(19) United States
(12) Patent Application Publication
(10) Pub. No.: US 2012/0121355 A1
(43) Pub. Date: May 17, 2012

(54) Surface Engraver

(75) Inventor: Darrel Adamson, Mansfield, MO (US)

(73) Assignee: Engrave-A-Crete, Inc.

(21) Appl. No.: 12/970,724

(22) Filed: Dec. 16, 2010

Related U.S. Application Data
(63) Continuation-in-part of application No. 29/379,035, filed on Nov. 12, 2010, now Pat. No. D638859.
(60) Provisional application No. 61/416,514, filed on Nov. 23, 2010.

(51) Int. Cl. B23C 1/20

(52) U.S. Cl. 409/181

(57) ABSTRACT

A handheld tool for engraving concrete, wood, composite or other surfaces using a motor is described. The surface engraver includes an adjustable depth stop, a cutter assembly, and various adjustable guides for controlling the engraving process. The cutter assembly is mounted on a chassis for moving the engraver over the surface during use, and is provided with a means for evacuating particles and other dust and debris created by the engraving process.

### CROSS REFERENCE TO RELATED APPLICATIONS

This application claims priority of U.S. provisional patent application Ser. No. 61/416,514, filed Nov. 23, 2010. This application is also a continuation-in-part of U.S. patent application Ser. No. 29/379,035, filed Nov. 12, 2010. The disclosures of aforementioned patent applications are incorporated herein by reference.

### BACKGROUND

1. Field of the Invention

The surface engraver described herein relates to devices for engraving surfaces of concrete, wood, composite or other materials. More specifically, the surface engraver is in the field of tools for engraving surfaces with decorative and structural grooves and other patterns.

2. Summary of the Invention

A surface engraver is described comprising a chassis, having a front member, a rear member and a right side member, with four wheels rotatably mounted at each corner of the chassis and a cutter assembly for supporting a motor with a blade; the cutter assembly is pivotally mounted on the chassis adjacent to the front end of the chassis; the cutter assembly further comprises a blade shield, a handle member, a depth stop assembly, and an actuator for the motor.

In embodiments of the surface engraver, the blade shield further comprises an exhaust port in a rear surface of the blade shield, and a drive port for a drive shaft of the motor; and the blade shield defines an interior volume substantially shielded on three sides by the blade shield.

In the described embodiment of the surface engraver, the depth stop assembly comprises a mounting block attached to the blade shield, a depth stop pin adjustably engaged by the mounting block, and a depth stop adjustment knob attached to the depth stop pin. In some embodiments of the surface engraver, the depth stop pin is threaded, and the mounting block is provided with a threaded hole for engaging the threads on the depth stop pin.

The actuator for the motor comprises an actuator member pivotally attached to the handle member, and the actuator member further comprises a grip member substantially parallel to the handle member and pivotally attached thereto at a first end thereof, an elbow member depending from the grip member adjacent to the pivotal attachment, and a pin extending substantially perpendicularly to the elbow member from the end thereof for engaging an actuator lever on the motor.

The surface engraver may be provided with a front line guide attached to the front end of the chassis for indicating the line of the blade, and a rear line guide attached to the rear end of the chassis. The surface engraver may also be provided with a plurality of mounting holes provided in the side member, and a front guide and a rear guide attached to the side member by the mounting holes; wherein the front guide indicates the leading cutting edge of the blade and the rear guide indicates the trailing cutting edge of the blade.

A guide support may be mounted on the chassis adjacent to the front end thereof, with a guide arm, having a first and second end, pivotally attached to the guide support by a first end thereof, a guide wheel rotatably attached to a second end of the guide arm; wherein the guide arm indicates the line of the blade.

In some embodiments of the surface engraver, a spring is provided between the depth stop mounting block and the chassis for pivoting the cutter assembly away from the chassis when not in use. An exhaust pipe may also be provided for directing debris through the exhaust port on the blade shield.

### BRIEF DESCRIPTION OF THE DRAWINGS

FIG. 1 is a perspective view of an embodiment of the surface engraver.

FIG. 1A is an exploded perspective view of an embodiment of the surface engraver.

FIG. 2 is a right side view of an embodiment of the surface engraver.

FIG. 3 is a left side view of an embodiment of the surface engraver.

FIG. 4 is a top plan view of an embodiment of the surface engraver.

FIG. 5 is a bottom plan view of an embodiment of the surface engraver.

FIG. 6 is a rear plan view of an embodiment of the surface engraver.

FIG. 7 is a front plan view of an embodiment of the surface engraver.

### DETAILED DESCRIPTION

The surface engraver is an improved and inventive tool for engraving the surface of concrete, wood, composite or other materials to provide decorative and functional scoring or grooving of the surfaces. The surface engraver is a convenient and economical handheld tool for precisely and consistently engraving such surfaces. The surface engraver may utilize commonly available pneumatic, electric or hydraulic motor to engrave the surface, and allows a user to control the motor with ease and precision.

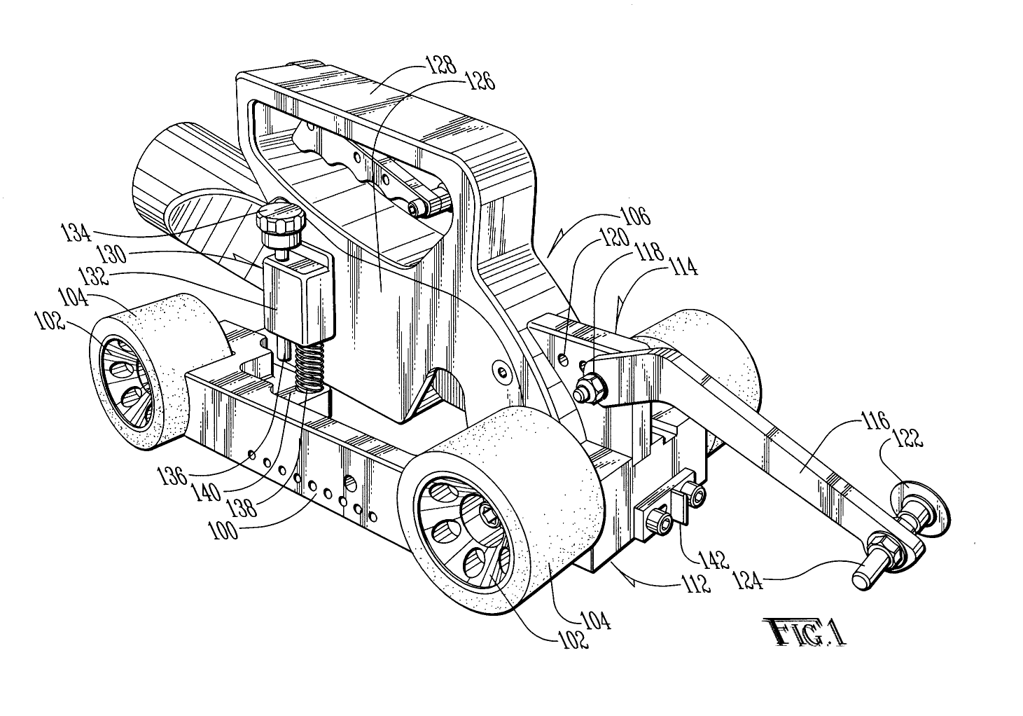

Referring now to FIG. 1, a perspective view of an embodiment of the surface engraver is depicted. The chassis 100 provides a support frame on which the other components of the surface engraver are attached. In the embodiment shown in the figures, the chassis comprises a front member extending across the front end of the engraver, a rear member extending across the rear end of the engraver, and a right side member connecting the front and rear members of the chassis. In other embodiments of the chassis there may be more members, such as a left side member without departing from the spirit of the invention.

The chassis 100 is mounted on wheels 102, which may be formed from machined or cast metal and provided with tires 104 formed from rubber, plastic or some other similar suitable material. The wheels 102 may be rotatably mounted on bolts that engage threaded mounting holes on chassis 100, or wheels 102 may be mounted on an axle that extend through the width of chassis 100 and are rotatably supported therein.

Chassis 100 may be machined or cast from metal or other material of appropriate strength and hardness. Although the chassis may be cast or machined from various materials, in some embodiments the chassis is machined from a metal such as aluminum. Alternatively it may be formed from components attached to each other by means of welding, bolts or other means of attachment.

A cutter assembly 106 is attached to the chassis 100. The cutter assembly 106 provides the support and control mechanism for controlling the motor 108 attached to the surface engraver. The motor 108 incorporates a blade 110 that is located inside the cutter assembly 106 when in use. Motor 108 and blade 110 are depicted in a later figure.

The cutter assembly 106 is pivotally attached to the chassis 100 at a point near the front end 112 of the chassis 100 to allow the motor 108 to be raised and lowered to control contact between the blade 110 and the surface. As will be described below, the cutter assembly 106 incorporates components to control the depth of the engraving, to actuate the motor, and to control the particulate matter that is released by the blade.

A guide support 114 is also attached to chassis 100 adjacent to the front end 112 of the chassis 100. A guide arm 116 is pivotally attached at a first end thereof to the guide support 114 by means of a fastener 118. The fastener 118 may be a nut and bolt combination or some other commonly used fastener for secure pivotal attachment. The guide support 114 may be provided with a plurality of mounting holes 120 for attaching the guide arm 116 to the guide support 114 at different spots as necessary. Guide support 114 also provides a mechanical stop to limit the rotation of cutter assembly 106.

Guide wheel 122 is attached adjacent to the second end of guide arm 116 and may freely rotate about the point of attachment. In the embodiment shown in the figures, guide wheel 122 is attached to a shaft 124, which is attached to a mounting hole in guide arm 116. In other embodiments, other means of attaching guide wheel 122 to guide arm 116 may be utilized.

The guide wheel 122 is disposed in line with blade 110 to provide the user with an external point of reference regarding the location of the blade 110 during operation of the engraver. When the guide wheel 122 is not needed for or would interfere with operation of the engraver, guide arm 116 may be pivoted around fastener 118 up and into a retracted position. The figures depict guide arm 116 in an extended position.

Cutter assembly 106 is pivotally attached to the chassis 100 adjacent to the first end 112 thereof. The cutter assembly comprises a blade shield 126 for blocking material ejected by the blade 110 and preventing unintended contact between the blade 110 and the user. In embodiments the blade shield may be formed from metal such as aluminum, but other metals or non-metal materials of appropriate strength and hardness may be utilized as well. The blade shield 126 may be machined or cast as a solid piece of material, or may be formed from various components attached together with welds, bolts, or other similar methods of fastening. In the embodiment shown in the figures, the right side of blade shield 126 is attached by means of a plurality of bolts and may be removed as necessary to access blade 110.

The blade shield 126 may have a handle member 128 attached to or incorporated into it for the user of the surface engraver during operation. The handle member 128 may also incorporate a means of actuating the motor 108, as will be described in relation to a later figure.

In embodiments of the surface engraver, a depth stop assembly 130 may be attached to the cutter assembly 106. The depth stop assembly 130 provides the user of the surface engraver with a device for controlling the depth of the cut made by the blade 110 when the user actuates the motor 108 and depresses the cutter assembly 106.

In the embodiment shown in the figures, the depth stop assembly comprises a mounting block 132, a depth adjustment knob 134 and a depth stop pin 136. The depth stop pin 136 may be translated up and down within mounting block 132 by turning depth adjustment knob 134. In the embodiment shown in the figures, user rotation of depth adjustment knob 134 causes pin 136 to translate up and down through mounting block 132 by means of threads on the pin and mounting block 132. Other methods of securing, releasing and adjusting depth stop pin 136 may be utilized by other embodiments of the engraver.

During use of the engraver, the bottom end of pin 136 contacts a portion of chassis 100 comprising a depth stop pad 140 and prevents cutter assembly 106 from pivoting further down and thus prevents blade 110 from cutting further into the surface being engraved than desired by the user.

A spring 138 may also be provided between mounting block 132 and pad 140 on chassis 100. The spring 138 forces cutter assembly 106 and chassis 100 apart and maintains blade 110 above the surface to be engraved until the user depresses the cutter assembly 106 by means of handle member 128 to overcome the force of spring 138.

A front line guide 142 is attached to chassis 100 on the front end 112 thereof. Front line guide 142 is aligned with the blade 110 and provides an external point of reference for the axis of the blade 110 as it is rolled on tires 104. Front line guide 142 may be attached to chassis 100 by screws, bolts or other commonly known methods of attachment. In the embodiment shown in the figures, the mounting holes in guide 182 for receiving bolts 184 may be slotted to allow the guide 182 to be adjusted for the thickness of blade 110.

Referring now to FIG. 1A, an exploded perspective view of an embodiment of the surface engraver is depicted. The grinder assembly can be seen removed from chassis 100. Mounting holes are provided in chassis 100 for accepting mounting bolts to secure the grinder assembly 106 to chassis 100 and allow it to pivot. In embodiments the mounting holes are threaded. In the embodiment shown in FIG. 1A the mounting bolts comprise set screws with conical ends. The set screws engage the threaded mounting holes and are disposed therein with the conical ends extending into holes or indentations provided in the grinder assembly 106. In other embodiments the mounting bolts may be common bolts, and bushings, bearings or other common methods of providing pivotal attachment may be utilized in place of conical ends on the bolts to engage the grinder assembly.

A portion of grinder shield 126 is shown removed from the other portions of the grinder shield 126 which are a unitary part of grinder assembly 106. The bolt or screw used to secure guide support 114 in mounting groove 190 is clearly depicted as removed from mounting hole 188.

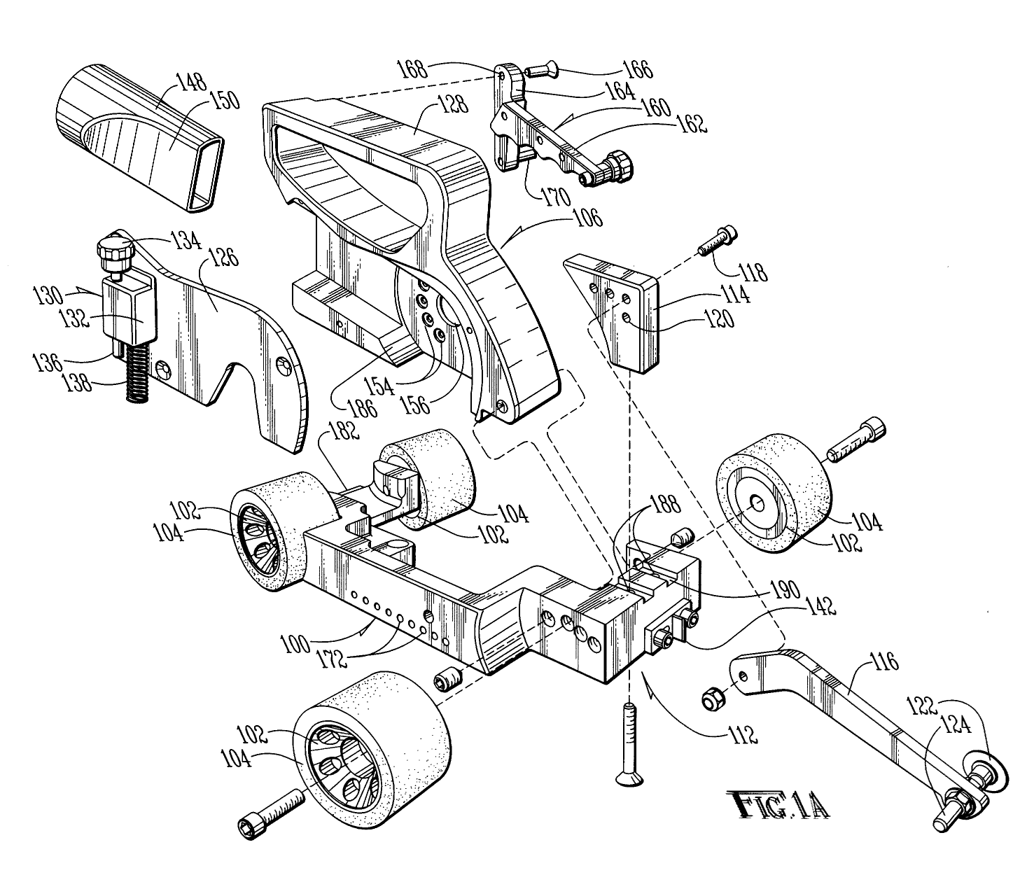

Referring now to FIG. 2, a right side view of an embodiment of the surface engraver is depicted. As described in relation to FIG. 1, the chassis 100 is supported by wheels 102 and tires 104. Cutter assembly 106 is pivotally attached to chassis 100 at a front end of assembly 106. Guide support 114 extends upwardly from chassis 100 adjacent to the front end of the chassis 100. Guide arm 116 is pivotally attached to guide support 114 at a first end thereof by a fastener 118. Guide arm 116 is depicted in FIG. 2 in a slightly raised position, with blade 122 above the location of the surface to be engraved.

Depth stop assembly 130 is attached to cutter assembly 106 as described in relation to FIG. 1. In the embodiment shown in the figures, bolts 144 are provided to adjustably attach mounting block 132 to cutter assembly 106.

Cutter assembly 106 is provided with an exhaust port 146 in the rear surface thereof, for guiding particulate matter, dust and debris out of the area of the blade 110. An exhaust pipe 148 may be provided to guide the debris from port 146 away from the engraver and the user of the engraver, or may be coupled to a vacuum hose attached to a debris containment system. In the embodiment shown in the figures, exhaust pipe 148 transitions from a circular cross-section near the outward end thereof to a rectangular cross-section at its interface with exhaust port 146 by means of parabolic surfaces 150. In other embodiments of the engraver, the exhaust pipe may be of uniform elliptical, rectangular or any other cross-section, or may have elbows, bends or curves as desired. The exact shape and configuration of exhaust pipe 148 is not limiting of the surface engraver described herein.

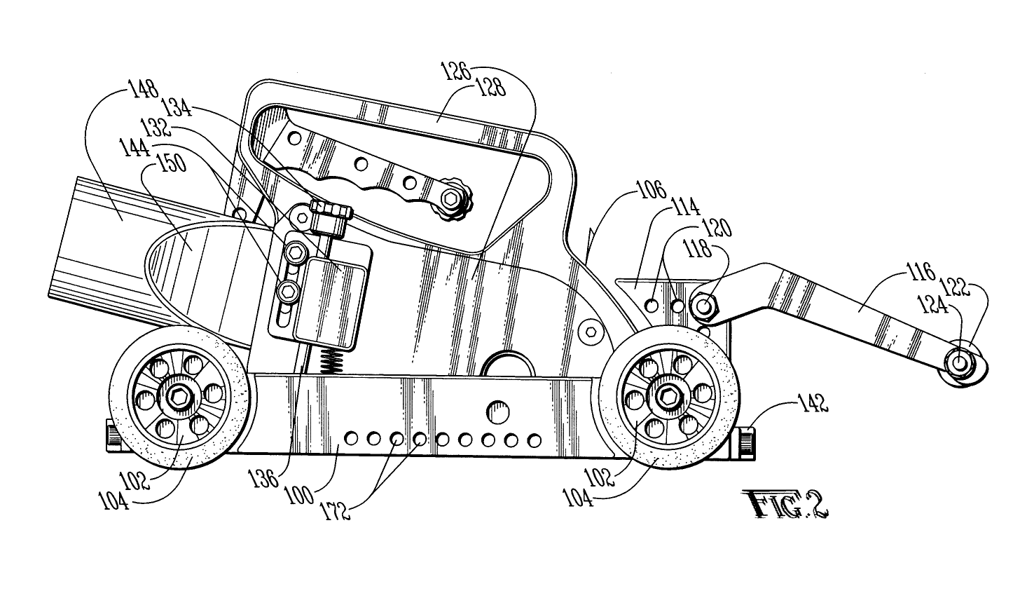

Referring now to FIG. 3, a left side view of an embodiment of the surface engraver is depicted. Motor 108 is attached to the left side of blade shield 126. The motor 108 shown in the figures is in the form of a pneumatic angle grinder, though this is not limiting of the invention. In the optional configuration shown in the figure, the handle area of the motor 108 extends upwardly and along the side of cutter assembly 106. In the embodiment the motor 108 incorporates an angle drive mechanism 152 which is releasably attached to blade shield 126 by bolts attached to mounting holes 154. The configuration of holes 154 may vary as needed to match mounting holes provided on motor 108. The drive shaft of motor 108 extends through drive port 156 into the interior volume of blade shield 126. Blade 110 is disposed on the end of drive shaft 156 inside shield 126.

The motor actuation mechanism incorporated in the engraver is more clearly depicted in this figure. Various manufacturers provide varying means of actuating their motors 108, and the actuation mechanism provided in an embodiment of the engraver may vary as necessary to engage the motor 108. In some embodiments, the actuation mechanism may mechanically actuate motor 108 and in others it may electrically, hydraulically or pneumatically actuate motor 108.

In many motors 108, actuation is accomplished by means of a lever 158 attached to the handle of the motor 108. When lever 158 is depressed the motor actuates, and engages the drive motor thus spinning the blade 110. The figures depict an embodiment of the engraver for engaging this type of motor actuator. In other embodiments of the surface engraver, differing motor actuation mechanisms may be provided for actuating motors with other means of actuation.

In the embodiment shown in the figures, actuator 160 is pivotally attached to handle 128. The actuator 160 comprises a grip area 162 and elbow 164 extending at right angles to one another from a point near pivot point 166. The actuator 160 is pivotally mounted to handle 126 at pivot point 166 by means of a fastener 168 such as a bolt. A pin 170 extends outward from elbow 164 and engages actuation lever 158 on motor 108.

During operation of the engraver, a user grips handle 128 with her fingers extending underneath grip 162. When the user desires to being engraving, the user squeezes the grip 162 against handle 128, thus pivoting actuator 160 around pivot point 166 and causing pin 170 to depress actuator lever 158. When lever 158 is sufficiently depressed it actuates the motor 108 and initiates grinding by blade 110.

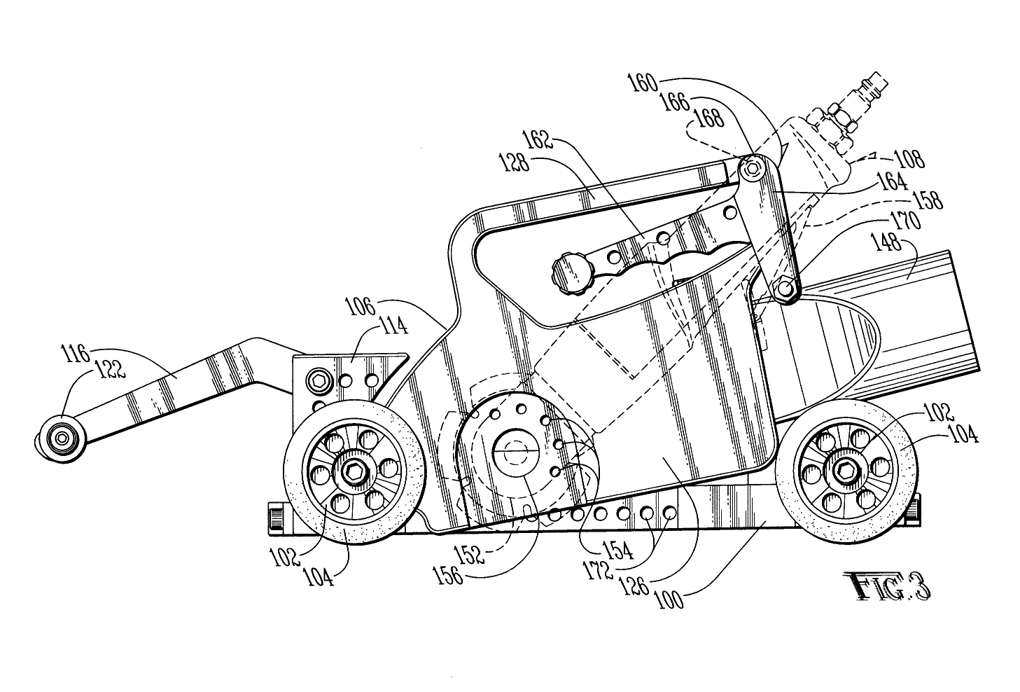

Referring now to FIG. 4, a top plan view of an embodiment of the surface engraver is depicted. The open-sided design of chassis 100 can clearly be seen in this figure, as there is a side member 174 on the right side of chassis 100, but no side member on the left side of chassis 100.

Front guide 176 and rear guide 178 are provided on side member 174 to provide the user of the surface engraver with a visual reference to the front and back cutting edges of the blade 110. Guides 176 and 178 allow the user of the surface engraver to begin and end cuts with precision. Guides 176 and 178 are mounted on side member 174 by bolts 180 which engage threads in mounting holes 172 in side member 174. Multiple mounting holes 172 may be provided to allow the guides 176 and 178 to be adjusted for differing diameters of blades 110. The mounting holes provided in guides 176 and 178 may be slotted to allow the position of the guides to be adjusted for changes in the diameter of blade 110 due to wear.

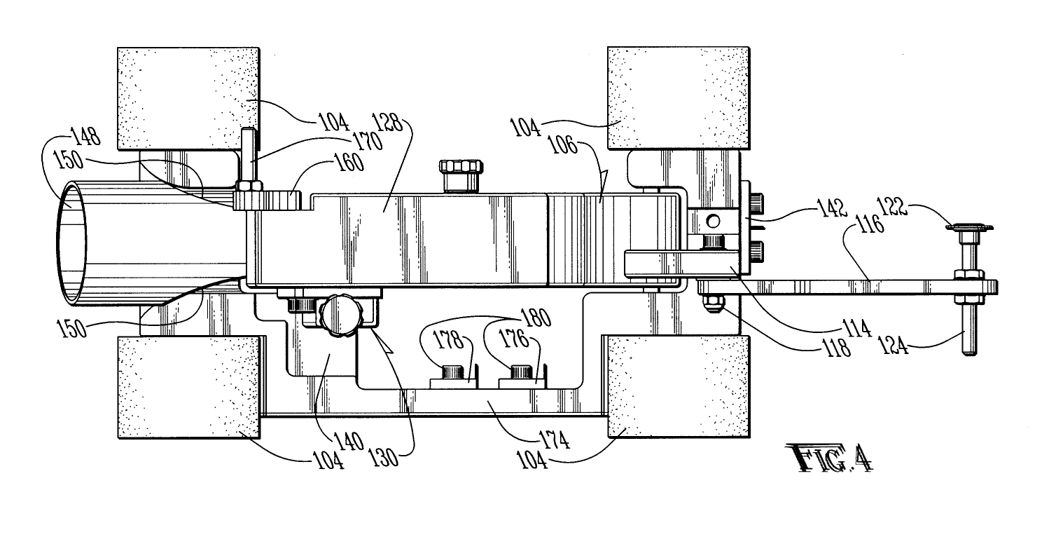

Referring now to FIG. 5, a bottom plan view of an embodiment of the surface engraver is provided. A rear line guide 182 is attached to the rear of chassis 100 by bolts 184 in line with blade 110. The mounting holes in guide 182 for receiving bolts 184 may be slotted to allow the guide 182 to be adjusted for the thickness of blade 110. The opening 186 in the bottom of blade shield 126 allows blade 110 to extend below the blade shield 126.

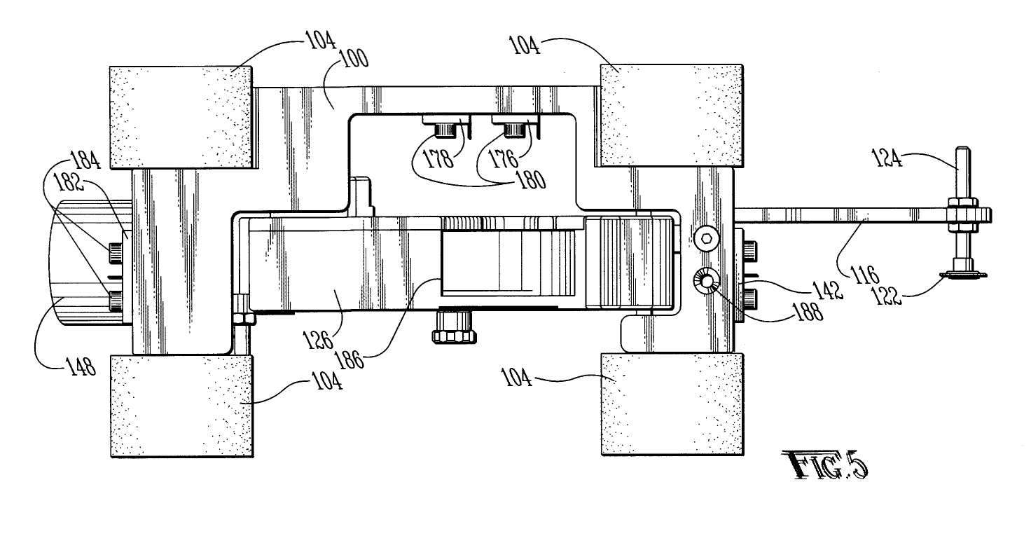

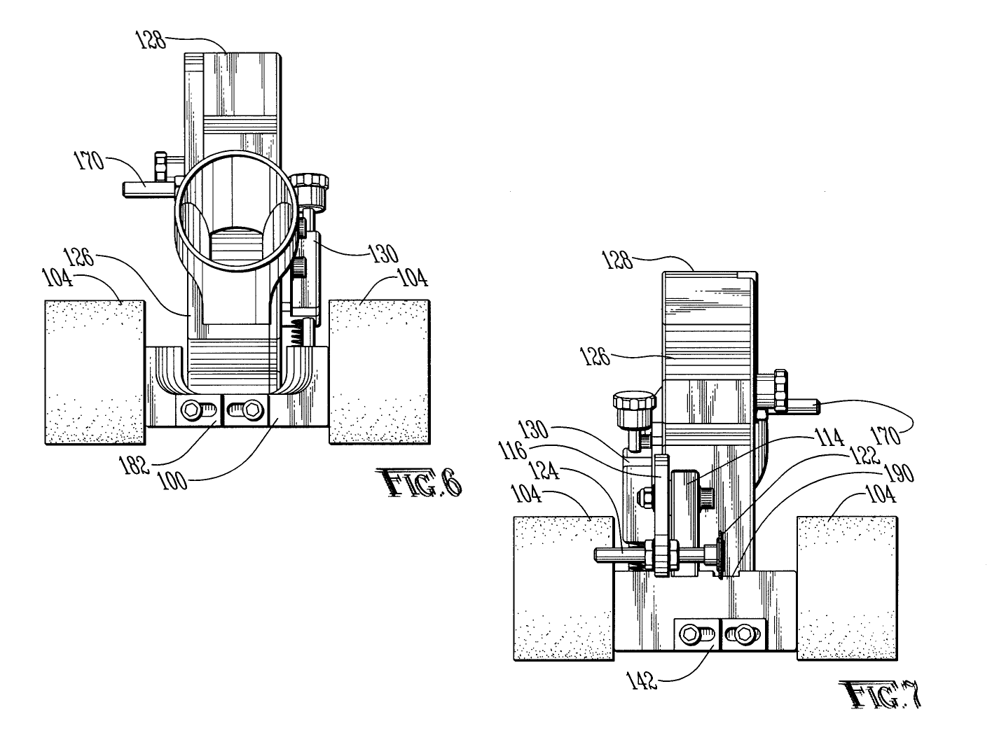

Referring now to FIGS. 6 and 7 respectively, a rear plan view and a front plan view of an embodiment of the surface engraver is depicted. The groove 190 adjacent to the front end of chassis 100 provides an alternative mounting location for guide support 114. The mounting hole 188 provides a means of attaching support 114 in groove 190. The bolt holding support 114 in its depicted position may be removed and the support 114 moved over to the groove 190, and the bolt replaced in its position. Arm 116 can then be removed and mounted on the opposite side of support 114 if necessary. Similarly shaft 124 may be removed from arm 116 and flipped horizontally to keep guide 122 in line with blade 110.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

What is claimed is:

1. A surface engraver comprising a chassis, having a front end, a rear end and a right side member, with four wheels rotatably mounted at each corner of the chassis and a cutter assembly for supporting a motor with a blade;
wherein the cutter assembly is pivotally mounted on the chassis adjacent to the front end of the chassis;
wherein the cutter assembly further comprises a blade shield, a handle member, a depth stop assembly, and an actuator for the motor.

2. The surface engraver of claim 1 wherein the blade shield further comprises an exhaust port in a rear surface of the blade shield, and a drive port for a drive shaft of the motor; and wherein the blade shield defines an interior volume substantially shielded on three sides by the blade shield.

3. The surface engraver of claim 2 wherein the depth stop assembly further comprises a mounting block attached to the blade shield, a depth stop pin adjustably engaged by the mounting block, and a depth stop adjustment knob attached to the depth stop pin.

4. The surface engraver of claim 3 wherein the actuator for the motor further comprises an actuator member pivotally attached to the handle member, wherein the actuator member further comprises a grip member substantially parallel to the handle member and pivotally attached thereto at a first end thereof, an elbow member depending from the grip member adjacent to the pivotal attachment, and a pin extending substantially perpendicularly to the elbow member from the end thereof for engaging an actuator lever on the motor.

5. The surface engraver of claim 4 further comprising a front line guide attached to the front end of the chassis for indicating the line of the blade, and a rear line guide attached to the rear end of the chassis.

6. The surface engraver of claim 5 further comprising a plurality of mounting holes provided in the side member, and a front guide and a rear guide attached to the side member by the mounting holes; wherein the front guide indicates the leading cutting edge of the blade and the rear guide indicates the trailing cutting edge of the blade.

7. The surface engraver of claim 6 further comprising a guide support mounted on the chassis adjacent to the front end thereof, a guide arm, having a first and second end, pivotally attached to the guide support by a first end thereof, a guide wheel rotatably attached to a second end of the guide arm; wherein the guide arm indicates the line of the blade.

8. The surface engraver of claim 7 wherein the depth stop pin is threaded, and the mounting block is provided with a threaded hole for engaging the threads on the depth stop pin.

9. The surface engraver of claim 8 wherein a spring is provided between the depth stop mounting block and the chassis for pivoting the cutter assembly away from the chassis when not in use.

10. The surface engraver of claim 9 wherein an exhaust pipe is provided for directing debris through the exhaust port on the blade shield.

11. A surface engraver comprising a chassis having a front member, a right side member and a rear member; four wheels mounted rotatably mounted on the chassis at the ends of the front and rear members of the chassis; and a cutter assembly pivotally mounted on the front member of the chassis;
wherein the cutter assembly further comprises a blade shield, a handle member, a depth stop assembly, and an actuator for the motor;
wherein the blade shield further comprises an exhaust port in a rear surface of the blade shield, and a drive port for a drive shaft of the motor; and wherein the blade shield defines an interior volume substantially shielded on three sides by the blade shield;
wherein the depth stop assembly further comprises a mounting block attached to the blade shield, a depth stop pin adjustably engaged by the mounting block, and a depth stop adjustment knob attached to the depth stop pin;
wherein the actuator for the motor further comprises an actuator member pivotally attached to the handle member, wherein the actuator member further comprises a grip member substantially parallel to the handle member and pivotally attached thereto at a first end thereof, an elbow member depending from the grip member adjacent to the pivotal attachment, and a pin extending substantially perpendicularly to the elbow member from the end thereof for engaging an actuator lever on the motor;
further comprising a front line guide attached to the front member of the chassis for indicating the line of the blade, and a rear line guide attached to the rear member of the chassis;
further comprising a plurality of mounting holes provided in the side member, and a front guide and a rear guide attached to the side member by the mounting holes;
wherein the front guide indicates the leading cutting edge of the blade and the rear guide indicates the trailing cutting edge of the blade;
further comprising a guide support mounted on the chassis adjacent to the front member thereof, a guide arm, having a first and second end, pivotally attached to the guide support by a first end thereof, a guide wheel rotatably attached to a second end of the guide arm; wherein the guide arm indicates the line of the blade;
wherein the depth stop pin is threaded, and the mounting block is provided with a threaded hole for engaging the threads on the depth stop pin;
wherein a spring is provided between the depth stop mounting block and the chassis for pivoting the cutter assembly away from the chassis when not in use;
wherein an exhaust pipe is provided for directing debris through the exhaust port on the blade shield.
